(19) United States
(12) Patent Application Publication
(10) Pub. No.: US 2006/0029256 A1
(43) Pub. Date: Feb. 9, 2006

(54) Method of generating image and device

(76) Inventors: Takashi Miyoshi, Atsugi (JP); Hidekazu Iwaki, Tokyo (JP); Akio Kosaka, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/192,317

(22) Filed: Jul. 28, 2005

(30) Foreign Application Priority Data
Aug. 9, 2004 (JP) 2004-232628

(51) Int. Cl. G06K 9/00

(52) U.S. Cl. 382/104

(57) ABSTRACT

A device for generating a viewpoint conversion image based on image data supplied from one or a plurality of imaging units arranged in a vehicle comprises a supplementary light source for illuminating an area to be imaged by the imaging units, and a control unit for selecting the casting directions of the supplementary light source in accordance with the viewpoint conversion image to be generated.

### CROSS REFERENCE TO RELATED APPLICATIONS

This application claims benefit of Japanese Application No. 2004-232628, filed Aug. 9, 2004, the contents of which are incorporated by this reference.

### BACKGROUND OF THE INVENTION

1. Field of the Invention

The present invention relates to a technique of generating an image, and particularly to a technique of synthesizing images captured by a plurality of imaging units into an image which appears as if it was actually captured from a viewpoint different from any of those of the imaging units, and displaying the synthesized image.

2. Description of the Related Art

Generally, when security cameras or the like are used for surveillance, captured images in units of cameras are displayed on a display monitor, and images captured by the cameras installed at desired positions in an area to be observed are displayed on a plurality of monitor devices arranged in a surveillance room. For safe driving, a camera facing backward is provided on a vehicle for imaging an area which a driver can not directly or indirectly view so that the image of the area is displayed on a display monitor provided near the driver's seat.

However, these observation devices image and display the images in units of cameras; accordingly, imaging of a wide area requires a large number of cameras. Further, when a wide angle camera is used for this purpose, though the number of cameras can be reduced, the resolution of the image displayed on a display monitor is lowered and the displayed image becomes difficult to viewed, so that the observation function is reduced.

Considering the above problems, techniques for synthesizing images by a plurality of cameras to display the images as one image are disclosed. As is disclosed in Japanese Patent Application Publication No. 5-310078 for example, there is a technique of displaying images by a plurality of cameras on a divided screen of one monitor device, or, as is disclosed in Japanese Patent Application Publication No. 10-164566, there is a technique in which the plurality of cameras are arranged so that portions of images imaged by the cameras are superposed upon one another, and the images are combined in the superposed portions, thereby, the images are synthesized into one image. Also, in Japanese Patent No. 3286306, images captured by the plurality of cameras are synthesized into one image by coordinate transformation so that a synthesized image from an arbitrary viewpoint is displayed.

In a method disclosed in Japanese Patent No. 3286306, a three-dimensional space model is generated in advance by triangulation or the like based on laser radar, millimeter wave radar or a stereo camera, image data of the plurality of cameras is unitarily loaded, mapping is conducted on the loaded image data making the image data correspond to respective pixel information which constitute the image input from the cameras, and thereby, spatial data is created. Then, after making the images from all the independent cameras correspond to a point in three-dimensional space, a viewpoint conversion image viewed from an arbitrary virtual viewpoint which is not the real viewpoint of the cameras is generated and displayed. According to the method of displaying the viewpoint conversion image, the entirety of the area to be observed from one arbitrary viewpoint is displayed without reducing image accuracy. Further, this method has the merit that the area to be observed can be confirmed from an arbitrary viewpoint.

### SUMMARY OF THE INVENTION

A method according to one aspect of the present invention is a method of generating an image in which the directions, in which supplementary light necessary for imaging is cast, are switched in accordance with the switching of viewpoints, and captured images acquired by imaging by one or a plurality of imaging units are converted to generate an image from a viewpoint which is different from the viewpoints of the imaging units.

Additionally, in the above method according to the present invention, it is possible that the supplementary light is at least one of visible light, infrared light and spatially modulated light.

Also, in the above method according to the present invention, it is possible that the supplementary light is cast on areas included in at least some of the captured images to be used for generating the image from the different viewpoint, and the supplementary light is not cast on areas outside the areas included in the captured images.

Also, in the above method according to the present invention, it is possible that the imaging unit is arranged in a vehicle.

A device according to another aspect of the present invention is a device for generating an image, which comprises a supplementary light source for illuminating an area to be imaged by one or a plurality of imaging units, a control unit for switching directions in which supplementary light necessary for imaging by the imaging units is cast, in accordance with the switching of viewpoints, and a viewpoint conversion image generation unit for converting captured images acquired by imaging, and generating an image from a viewpoint which is different from the viewpoints of the imaging units.

Additionally, in the above device according to the present invention, it is possible that the supplementary light source is provided to the imaging unit.

Also, in the above device according to the present invention, it is possible that the supplementary light source is provided being independent from the imaging unit and corresponding to the image from the different viewpoint.

Also, in the above device according to the present invention, it is possible that the supplementary light source illuminates the area to be imaged by at least one of visible light, infrared light and spatially modulated light.

Also, in the above device according to the present invention, it is possible that the imaging unit is arranged in a vehicle.

Also, in the above device according to the present invention, it is possible the supplementary light source is arranged in an object in which the imaging unit is arranged, together with the imaging unit.

### BRIEF DESCRIPTION OF THE DRAWINGS

The present invention will be more apparent from the following detailed description when the accompanying drawings are referenced.

FIG. 1 is a system configuration block diagram of an image generation device for implementing the present invention;

FIG. 2 shows a schematic configuration of a stereo camera unit;

FIG. 3 shows a schematic configuration of an illuminator for the illumination in the case when supplementary light is spatially modulated light;

FIG. 4A shows a first example of spatially modulated light;

FIG. 4B shows a second example of spatially modulated light;

FIG. 5 is a configuration block diagram in the case where an image generation device for implementing the present invention is provided in a vehicle;

FIG. 6 is a flowchart for showing the process order of generating a distance image when a stereo camera unit of the stereo adapter type is used;

FIG. 7 is a flowchart for showing the process order in a method of generating an image;

FIG. 8 is a system block diagram in the case where the image generation device for implementing the present invention is applied to a room;

FIG. 9 is a flowchart for showing the process order in the method of generating an image in the case where the image generation device for implementing the present invention is applied to a room;

FIG. 10A shows an arrangement example for applying the image generation device for implementing the present invention to a room in which the light is cast before following; and

FIG. 10B shows an arrangement example for applying the image generation device for implementing the present invention to a room in which the light is cast after following.

### DESCRIPTION OF THE PREFERRED EMBODIMENTS

Hereinafter, specific embodiments of a method of generating an image and a device according to the present invention will be explained in detail by referring to the drawings.

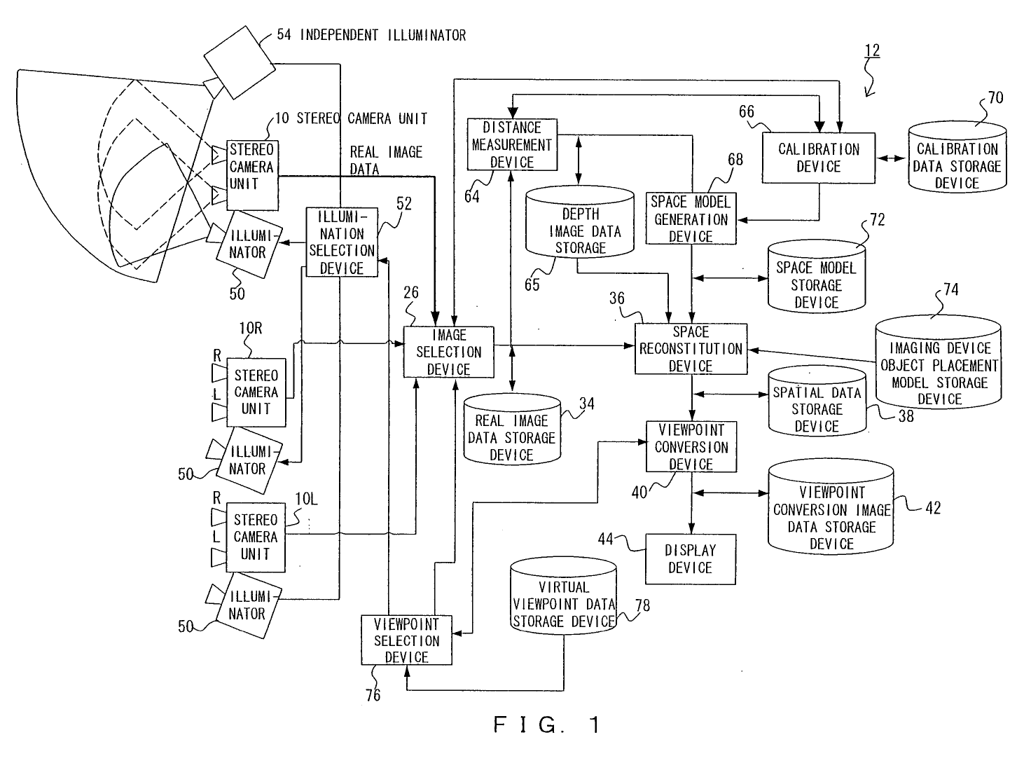

FIG. 1 is a system configuration block diagram of an image generation device for implementing the present invention. In this embodiment, this system employs a plurality of stereo camera units 10 as imaging units, and this system comprises the above stereo camera units and a viewpoint conversion synthesized image generation/display device 12 for processing image data acquired by the stereo camera units 10, and reproducing/displaying the image as the synthesized image viewed from a virtual viewpoint which is different from the viewpoints of the cameras.

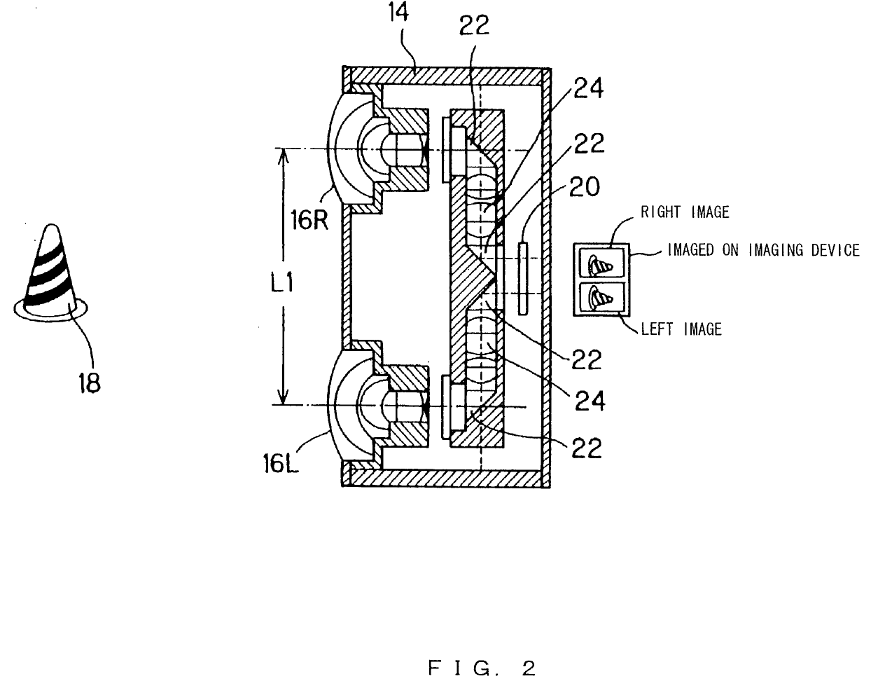

FIG. 2 shows a schematic configuration of the stereo camera unit 10. As shown, the stereo camera unit 10 uses a stereo adapter. On right and left portions on a front face of a casing 14, a pair of wide angle converter lenses 16L and 16R each including a group of receiving lenses are provided an interval L1 apart so that the stereo camera unit 10 can conduct stereo imaging of an object 18.

An imaging device 20 for receiving imaging light input via the wide angle converter lenses 16L and 16R is arranged at the middle portion of the back face of the casing 14, and in the right and left regions of the imaging device 20, images of the object from the right and left wide angle converter lenses 16R and 16L, respectively, are imaged. For this purpose, between the imaging device 20 and each of the right and left wide angle converter lenses 16R and 16L, light-guiding optical systems each including deflection prisms 22 and imaging lens systems 24 are arranged, and an object image captured by the left wide angle converter lens 16L and an object image captured by the right wide angle converter lens 16R are respectively guided to the left region of the imaging device 20 and the right region of the imaging device so that they are simultaneously imaged on a focal plane of one imaging device 20 being divided into left and right sides.

The image of the object 18 as an obstacle incident on right and left lenses, is refracted by the deflection prisms 22, and is captured on the imaging device. Thereby, a stereo image is captured on a single imaging device. A depth image is generated by cutting out a prescribed right image region and left image region from the pair of images in stereo.

Additionally, two of the above stereo camera units 10 can be arranged in a pair so that optical axes of the units 10 are parallel. Thereby, the length of the baseline which is the distance between the light sensing units can be switched between the short baseline length of a single stereo camera unit 10 and a long baseline length of a pair of stereo camera units (10R and 10L) for stereo imaging.

Also, in the viewpoint conversion synthesized image generation/display device 12, basically processes are executed in which input images captured from the viewpoint of each stereo camera unit 10 are acquired, a three-dimensional space including an object in which the imaging units are arranged is set, the three-dimensional space is identified by an arbitrarily set origin (virtual viewpoint), a correspondence between the above identified three-dimensional space viewed from the virtual viewpoint and the pixels in the image data is made by conducting a coordinate transformation on the pixels, and the pixels are rearranged on an image plane viewed from the virtual viewpoint. Thereby, an image in which the pixels of the image data acquired by the imaging from the viewpoint of the camera are rearranged and synthesized in the three-dimensional space defined by the virtual viewpoint can be obtained so that the synthesized image from a desired viewpoint which is different from the viewpoint of the camera can be generated and output to be displayed.

Additionally, this system transmits the images captured by each stereo camera unit 10 in packet transmission. For this purpose, a buffer device is provided in the stereo camera unit 10 as the imaging unit so that the captured images are temporarily stored in buffer memory included in the buffer device. In this buffer device, each unit of captured image is assigned an ID (identification information), and at least one of time stamp, imaging unit position/angle information, an internal parameter of the imaging unit or exposure information is included in the ID. Thereby, image data transmitted from each stereo camera unit 10 is successively transmitted in packets to the viewpoint conversion synthesized image generation/display device 12, in such a state that the data includes the timestamp and other imaging data.

Again, FIG. 1 will be explained.

To the viewpoint conversion synthesized image generation/display device 12 for receiving image data from the stereo camera units 10, the image data is transmitted from each stereo camera unit 10, and image data to be acquired from each stereo camera unit 10 is determined exclusively in accordance with the set virtual viewpoint, therefore, an image selection device 26 is provided for acquiring the image data that corresponds to the set virtual viewpoint. By this image selection device 26, image data packets that correspond to the set virtual viewpoint are selected from among image data packets input from the buffer device provided in each stereo camera unit 10, and the selected image data packets are utilized in an image synthesis process executed in a later stage.

The image data is stored in the camera buffer device in units of image data with IDs by packet transmission; accordingly, by using the ID information, image data imaged at one time can be combined. Accordingly, in the viewpoint conversion synthesized image generation/display device 12, a real image data storage device 34 is provided for ordering and storing, in chronological order, the captured images from the plurality of stereo camera units 10 based on the ID information.

In addition, when the parameters are not synchronized among the acquired image data, the synthesized image departs from the real situation. In order to avoid this phenomenon, at least one of the time stamp, the imaging unit position/angle information, the internal parameter of imaging unit and the exposure information is included in the ID as described above, and the adjustment is conducted among the image data to be used for constructing the three-dimensional space, as occasion demands.

A distance measurement device 64 conducts a distance measurement by stereo imaging in the present embodiment. Upon this, a radar such as a laser radar, a millimeter wave radar or the like can be used together.

In the distance measurement by stereo imaging, one and the same object is imaged from a plurality of different viewpoints, the correspondence among the captured images regarding one and the same point of the object is obtained, and the distances to the object are calculated based on the above correspondence by using the principle of triangulation. More specifically, the right image region of the images imaged by the stereo camera unit is divided into small regions and the scope about which the stereo distance measurement calculation is executed is determined, next, the position of the image which is recognized to be the same as each of the above small regions is detected from the left image region. Then, the difference in position of these images is calculated, and the distances to the object are calculated from the relationship among the above calculation result and the mounting positions of the right and left cameras. Based on the depth data obtained by the stereo distance measurement by one or more pairs of images imaged by the stereo camera, a depth image is generated.

A calibration device 66 determines and identifies camera parameters, which specify the camera's characteristics, such as the mounting position of the imaging unit in a three-dimensional real world, a mounting angle, a lens distortion compensation value, the focal length of a lens and the like, regarding the imaging unit arranged in the three-dimensional real world. The camera parameters obtained by the calibration are temporarily stored in a calibration data storage device 70 as calibration data.

Image data of the stereo camera unit 10 and depth image data of the distance measurement device 64 stored in a depth image data storage device 65 are input to a space model generation device 68 as a space model update unit. The space model generation device 68 generates the space model by using the image data of each stereo camera unit 10 and the depth image data of the distance measurement device 64, and temporarily stores the generated space model in a space model storage device 72. Because the depth data having a good depth resolution and expressing the shape of the object such as an obstacle is obtained, depth resolution of the generated space model and reproduction performance of the object shape are enhanced.

Each pixel of the image data thus selectively loaded is made to correspond to a point in the three-dimensional space by a space reconstitution device 36, and the pixels are reconstituted as spatial data. Specifically, the positions at which respective objects that constitute the selected image exist are calculated. The spatial data as the calculation result is temporarily stored in a spatial data storage device 38.

A viewpoint conversion device 40 reads the spatial data created by the space reconstitution device 36 from the spatial data storage device 38, and reconstitutes an image viewed from the set virtual viewpoint. This can be called an inverse transformation of a process executed by the space reconstitution device 36. Thereby, the image viewed from a new conversion viewpoint is generated based on the data read from the spatial data storage device 38. Data of the acquired image is temporarily stored in a viewpoint conversion image data storage device 42, and thereafter, is displayed on a display device 44 as a viewpoint conversion image.

Also, in the viewpoint conversion synthesized image generation/display device 12, an imaging device object placement model storage device 74 is provided for storing data of an imaging device object placement model such as a model of the vehicle itself so that the imaging device object placement model can be simultaneously displayed together with the image generated by the space reconstitution. Also, a viewpoint selection device 76 is provided for transmitting, to the viewpoint conversion device 40, the image data corresponding to the predetermined set virtual viewpoint stored in a virtual viewpoint data storage device 78 in advance, as soon as the viewpoint selection process is executed so that the conversion image corresponding to the selected virtual viewpoint is displayed on the display device 44.

Further, in the present embodiment, in accordance with the movement of the virtual viewpoint in the viewpoint conversion image, the image data packets from the necessary imaging unit are acquired from the camera buffer device in advance. Therefore, unnecessary data processes are not executed so that speed of the image synthesis process is increased, which brings about an effect that the present invention is suitable for the application of a moving object such as a vehicle that requires instantaneity.

Incidentally, in the present embodiment, an illuminator 50 as a supplementary light source for illuminating an area imaged by the stereo camera unit 10 as the imaging unit is provided to each stereo camera unit 10. Also, an independent illuminator 54 is provided corresponding to the viewpoint conversion image to be generated, independently from the stereo camera unit 10. A control unit is provided to this illuminator 50 or this independent illuminator 54, which switches and selects each viewpoint conversion image. In the configuration shown in FIG. 1, the function of the control unit is performed by an illumination selection device 52.

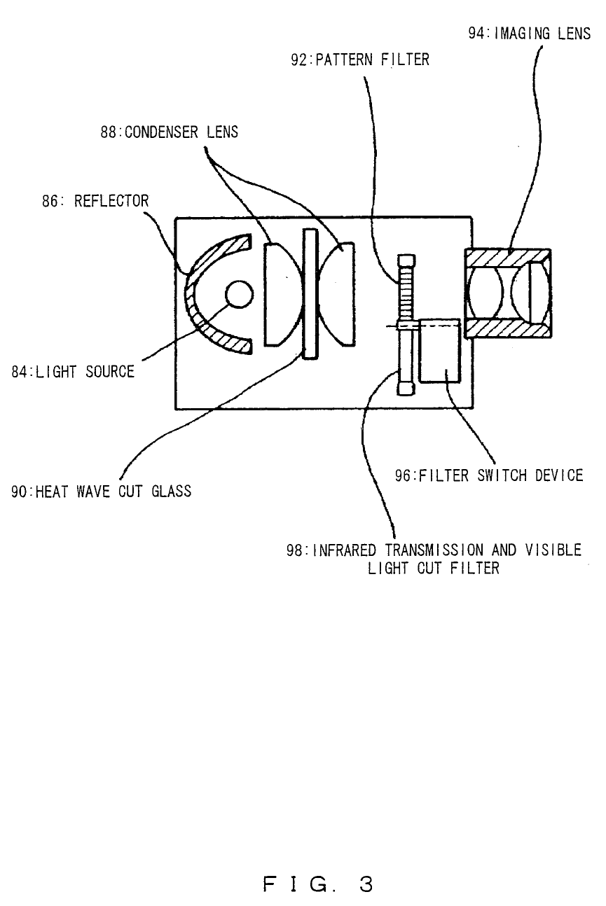

FIG. 3 shows a schematic configuration of the illuminator 50 for illumination in the case where supplementary light is spatially modulated light.

When a light beam emitted by a light source 84 is shaped by a reflector 86 and a condenser lens 88 and heat rays of the light beam are cut by a heat cut glass 90, and thereafter, the light beam reaches a pattern filter 92, an image of the pattern filter 92 is cast on an object such as an obstacle by an imaging lens 94. Additionally, upon this, by using a filter switch device 96, not only the spatially modulated light generating the above image, but also the illumination light can be cast. Also, by removing the heat cut glass 90 and replacing the pattern filter 92 with an infrared transmission and visible light cut filter 98, an illuminator that switches between infrared illumination and visible light illumination can be realized.

In the present embodiment, upon the selection of the virtual viewpoint, the stereo camera unit 10 which corresponds to the virtual viewpoint is selected by the image selection device 26, while, the illuminator 50 corresponding to the selected stereo camera unit 10 is selected by the illumination selection device 52, so that only the selected illuminator 50 is operated. Thereby, the direction the supplementary light is cast in by the illuminator 50 is switched, and the supplementary light is cast only on the area imaged by the stereo camera units 10 that images necessary images for the generation of the virtual viewpoint image. Accordingly, energy for illumination light is saved and the probability of dazzling of the sensors of other vehicles can be lowered.

Also, as the supplementary light cast by the illuminator 50, one of visible light, infrared light, spatially modulated light, or a plurality of them by the switching in time series is used. Upon this, when visible light is cast, an object to be imaged in a dark place or in a situation against the light can be imaged in detail. When infrared light is used, a detailed image can be acquired regarding the dark region and the imaging at night time.

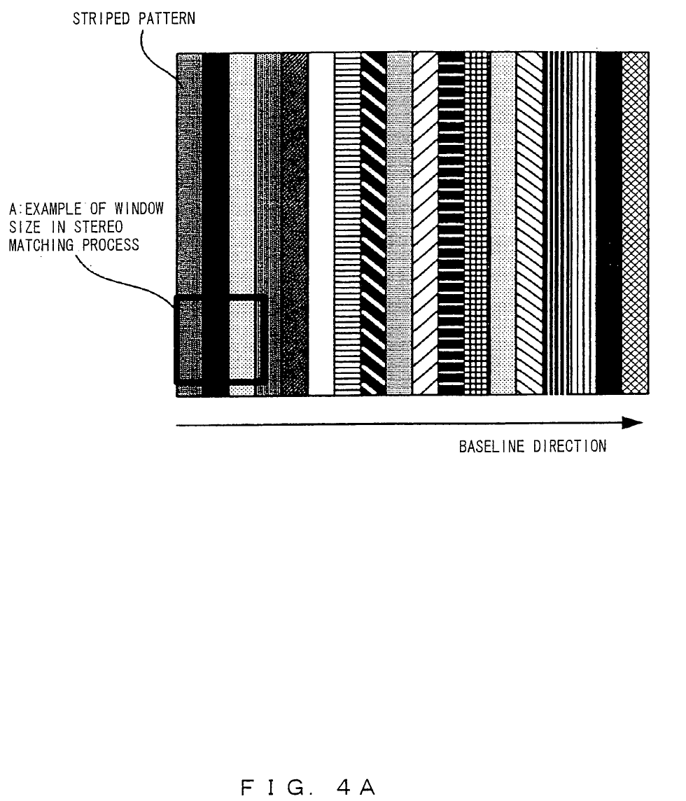

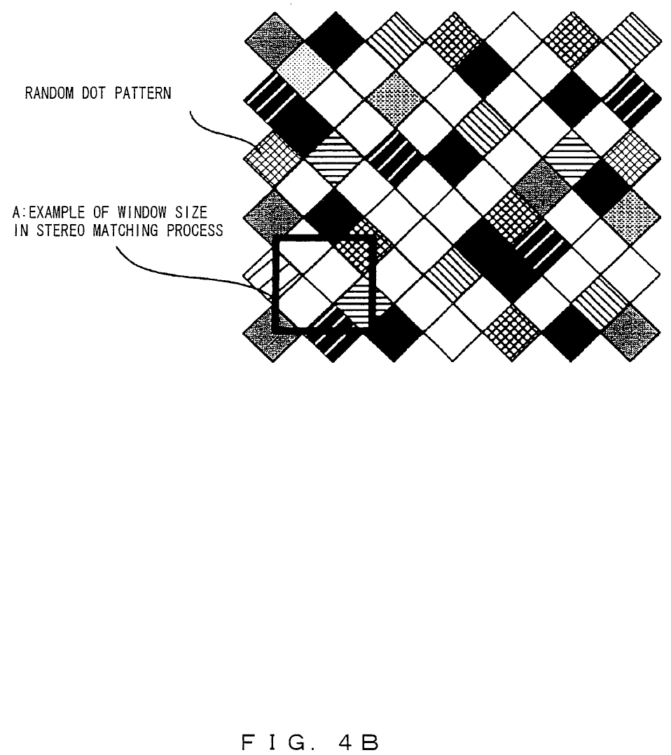

Further, by using spatially modulated light as the supplementary light, upon the stereo distance measurement, the shape measurement of a homochromatic plane and the like with a few characteristic points can be suitably conducted, so that the generation of the space model can be advantageously implemented. Examples of spatially modulated light are shown in FIG. 4A and FIG. 4B. As shown, as spatially modulated light, for example, a striped pattern in which the pattern which is coded by colors or the like with respect to the baseline direction (the direction of the arrow) (FIG. 4A), or a random dot pattern in which the point can easily be identified upon cut out, for example, of the template matching in the window size upon the stereo distance measurement (FIG. 4B) can be used. The difference of colors is shown by the difference of hatching pattern. Also, FIG. 4A and FIG. 4B are the portions cut out of the patterns, and the actual pattern is finer than the shown ones. Additionally, the symbol A in the figures denotes the window size upon the stereo matching process.

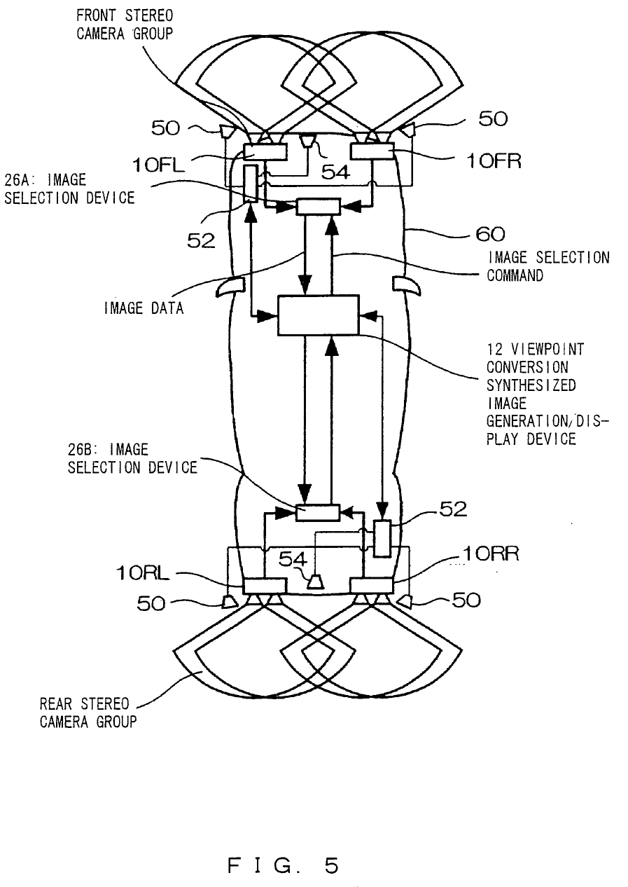

FIG. 5 is a configuration block diagram in the case where the image generation devices for implementing the present invention are provided in a vehicle to observe the surrounding situation for aiding driving of the vehicle.

As shown, a plurality of stereo camera units 10 as imaging units are provided at the front and rear portions of a vehicle 60 as the imaging device arranged object. In the example shown, a front camera group 10F (10FR and 10FL) is provided at the front portion of the vehicle 60, whose cameras 10FR and 10FL are respectively provided on the right and left sides of the front portion. Also, a rear camera group 10R (10RR and 10RL) is provided at the rear portion of the vehicle 60, whose cameras 10RR and 10RL are respectively provided on the right and left sides of the rear portion.

The vehicle 60 comprises the viewpoint conversion synthesized image generation/display device 12 for synthesizing images imaged by the stereo camera units 10 and for generating an image which appears to have been imaged from an arbitrary viewpoint different from those of the stereo camera units 10. The viewpoint conversion synthesized image generation/display device 12 and each stereo camera unit 10 is connected by LAN (Local Area Network) via the image selection devices 26 (26a and 26b), and image data is transmitted in packets via each camera buffer. Thereby, necessary image data which is exclusively determined as the necessary data for each of the set virtual viewpoints can be selected from the data buffer devices to be loaded in rapidly by packet transmission, can be subjected to image processing, and can be displayed. Therefore, the speed of image display is increased, so that synthesized images are displayed rapidly.

Also, the illuminator 50 is provided to each stereo camera unit 10. Further, the independent illuminator 54 is also provided for a unit of viewpoint conversion image. The illuminator 50 and the independent illuminator 54 are connected to the viewpoint conversion synthesized image generation/display device 12 via the illumination selection device 52. Thereby, the illuminators 50 can be arbitrarily selected in accordance with the virtual viewpoint.

Additionally, for a moving object such as the vehicle 60, it is frequently required that a obstacle is immediately displayed on the display device 44 nearby a driver's seat in order to prompt the driver to dodge when there is a obstacle. In the present embodiment, by a distance measurement device 64 provided in the vehicle 60, or by a range sensor function provided to the camera, the stereo camera unit 10 as the imaging unit that can display an obstacle is identified, image data of the camera is read in advance, and the data is output and displayed on the display device 44 when an object is recognized.

Next, a method of generating the viewpoint conversion image for the image generation device in the above configuration will be explained in detail.

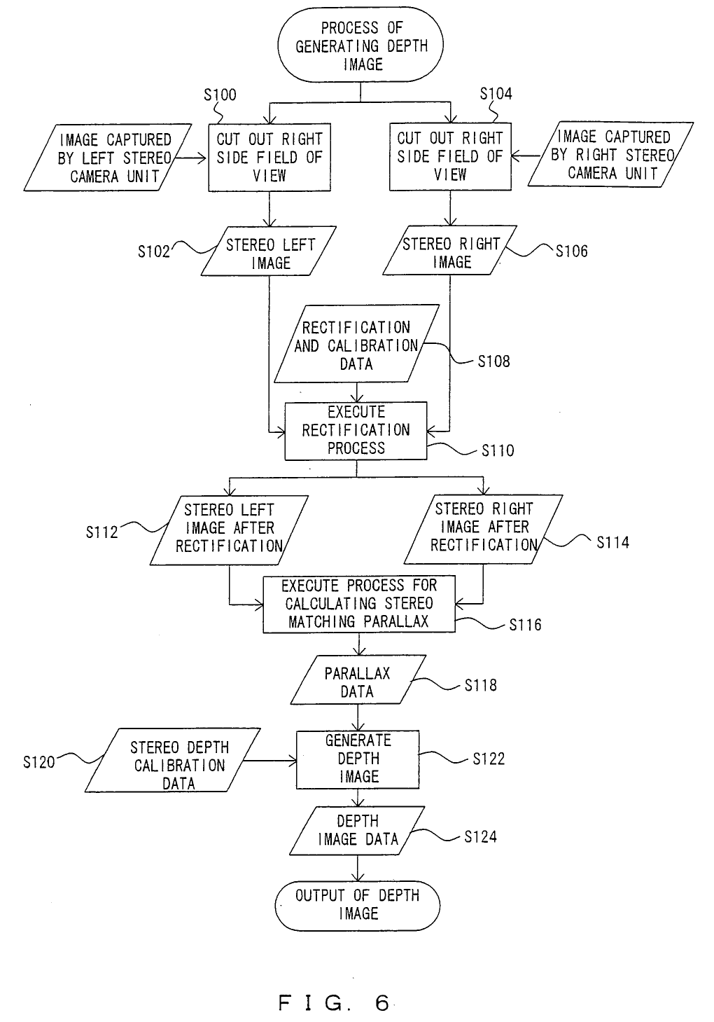

First, a flowchart of processes for generating a distance image when the stereo camera unit of the stereo adapter type is used is shown as FIG. 6. These processes are executed in the distance measurement device 64 to which real image data and calibration data are input.

In the following explanation, the case is employed where right side field of view images (right side of the right stereo camera unit 10R and right side of the left stereo camera unit 10L) which constitute a stereo pair among images imaged by the right stereo camera unit 10R and the left stereo camera unit 10L are used.

First, in S100 and S104, process are executed in which the right side field of view portions of the images imaged respectively by the stereo camera unit 10R and the stereo camera unit 10L are cut out each in a predetermined size. And, a stereo left image (S102) and a stereo right image (S106) are generated.

Next, based on calibration data (S108) for the rectification, the compensation of the distortion aberration of the right and left stereo images, respectively, is conducted, and the rectification process is conducted in which the images are geometrically converted in order that the corresponding points of the right and left images are on the epipolar line, by the distance measurement device 64 in S110. Additionally, this calibration data is about the baseline length in accordance with the right side cameras of the selected stereo camera units 10R and 10L respectively, internal and external camera parameters and the like, and is created in advance by conducting calibration by the calibration device 66.

Next, stereo matching is conducted on a stereo left image (S112) and a stereo right image (S114) after the rectification, the search is made for the corresponding points, and a process for calculating the parallax is executed in S116. Thereby, a map of the amount of parallax at each point of the image is created, and the created map becomes parallax data (S118).

Next, based on stereo depth calibration data (S120), the amount of parallax at each point of the image is converted into the distance from a reference point, and a process for creating the depth image data is executed in S122. Additionally, this stereo depth calibration data is about the baseline length in accordance with the right side cameras respectively of the selected stereo camera units 10R and 10L, the internal and external camera parameters and the like, and is created in advance by conducting calibration by the calibration device 66.

As above, the depth image data (S124) is generated and output.

By conducting the above processes, the depth image data can be calculated from the images imaged by the plurality of the stereo camera units 10. The obtained depth image data is used for generating the space model which will be explained later. Additionally, the depth image data can also be acquired by conducting the same processes on the left side field of view images (left side of the right stereo camera unit 10R and left side of the left stereo camera unit 10L) which constitute a stereo pair.

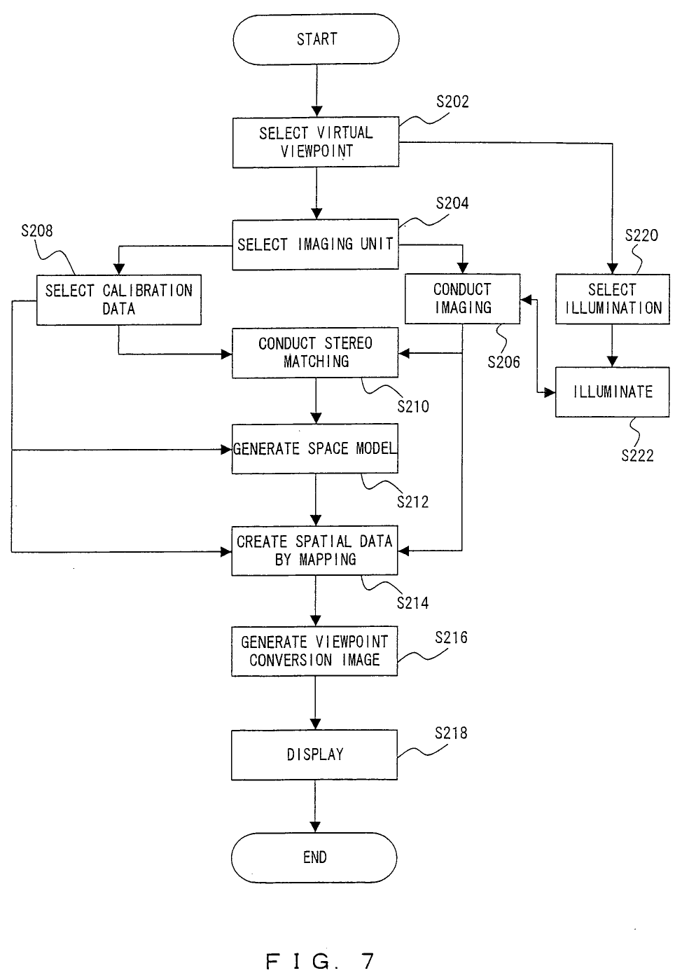

Next, a method of generating an image by using the image generation device according to the present invention will be explained by referring to FIG. 7. FIG. 7 is a flowchart for showing process order in the method of generating an image.

First, in S202, an arbitrary virtual viewpoint to be displayed is selected by the viewpoint selection device 76.

In S204, a selection between stereo imaging of the short baseline and stereo imaging of the long baseline by the plurality of the stereo camera units 10 is made by the image selection devices 26.

In S206, imaging is conducted by the selected stereo camera units 10. Then, upon generation of a space model of the long baseline side for example, the side images which are on the same side in the divided field of view of the image in which the imaged right and left images are imaged are cut out and are used as a stereo pair image for generating the space model.

In S208, the calibration to be used for a stereo matching is beforehand conducted by the calibration device 66, and the calibration data such as baseline length in accordance with the selected stereo camera units 10, internal and external camera parameters and the like is created.

In step S210, stereo matching of the selected captured image is conducted based on the acquired calibration data by the distance measurement device 64. Specifically, the prescribed windows are cut out from the right and left images upon viewing the images as the stereo image, and the value of normalized cross correlation and the like, of the window images are calculated while scanning the epipolar line so that the corresponding points are searched and the parallax between the pixels of the right and left images is calculated. Then, from the calculated parallax, the distance is calculated based on the calibration data, and the obtained depth data is recognized as the depth image data.

In step S212, the image data of the stereo camera units 10, and the depth image data obtained by the distance measurement device 64 are input to the space reconstitution device 36 serving as a space model update unit, and the above information is selectively used at a desired distance, thereby, a space model which is more detailed than the model generated by the space model generation device 68 is generated.

In step S214, in order to acquire the real image data corresponding to this space model, the image acquired by the imaging unit is mapped to the three-dimensional space model in accordance with the calibration data by the space reconstitution device 36. Thereby, spatial data which has been subjected to texture mapping is created.

In step S216, a viewpoint conversion image which is viewed from a desired virtual viewpoint is generated by the viewpoint conversion device 40 based on the spatial data created by the space reconstitution device 36.

In step S218, the viewpoint conversion image data generated as above is displayed on the display device 44.

Also, subsequently to the selection of the virtual viewpoint (S202) in this process, in S220, the stereo camera unit 10 in accordance with the virtual point is selected by the image selection device 26, and also, the illuminator 50 corresponding to the selected stereo camera unit 10 is selected by the illumination selection device 52.

In the subsequent S222, only the selected illuminator 50 is operated, and the light is cast. Thereby, only the area corresponding to the virtual viewpoint is illuminated by the supplementary light, while, the area outside the above corresponding area is not illuminated by the supplementary light, so that the energy for illumination light is saved and the probability of the dazzling of the sensors of other vehicles due to unnecessary illumination can be lowered.

Additionally, in the above embodiment, the example is employed where the imaging units such as camera unit 10 and the like are provided in the vehicle 60 as a target in which the units are arranged in a prescribed form, however, similar implementations of image generation are possible even when the above imaging units are provided in a pedestrian, a street, a building such as a store, a house, an office or the like serving as the imaging device arranged object. By the above configurations, the present invention can be applied to a wearable computer attached to a security camera or a human body for acquiring image-based information.

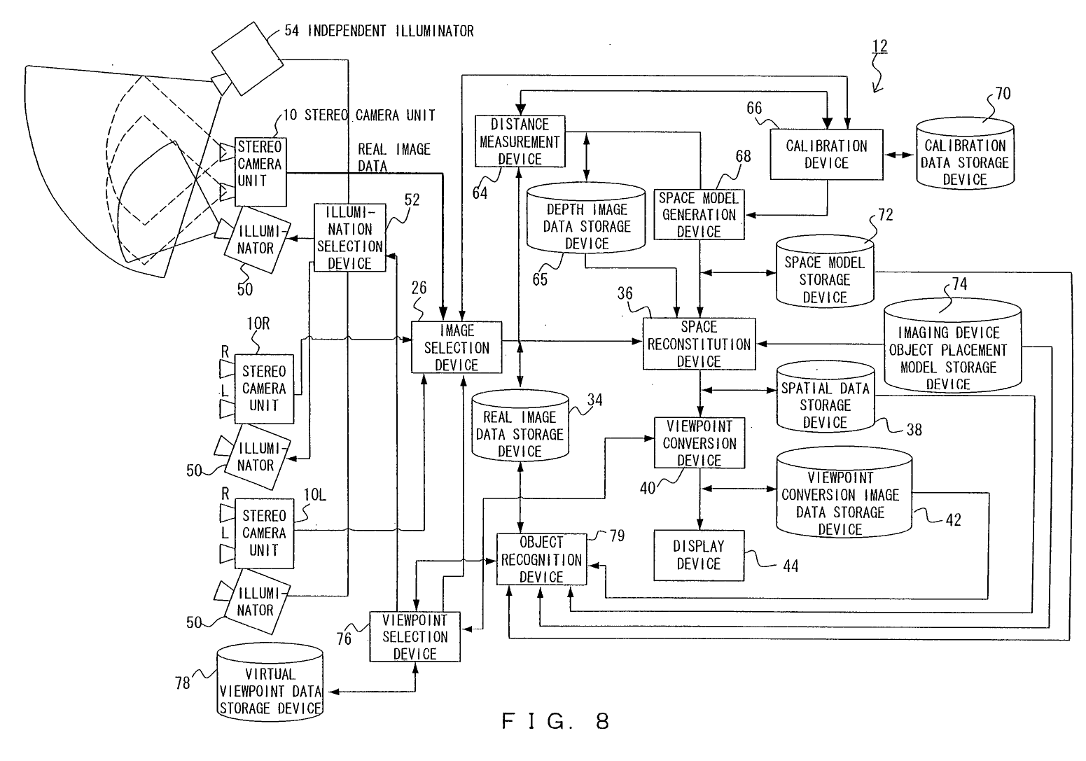

Next, a system block diagram for the case where the image generation device for implementing the present invention is applied to a room is shown. In FIG. 8, like components having the same effects as those in FIG. 1 are denoted by like numerals, and their explanations will be omitted.

In the configuration of FIG. 8, in addition to the illuminator 50 provided to the stereo camera unit 10, the independent illuminator 54 which is needed for the generation of the space model by the three-dimensional reconstitution and is suitable for measuring distances to a person as a moving obstacle, interior furniture or the like in the room is provided and connected to the illumination selection device 52.

Also, an object recognition device 79 is connected to the viewpoint selection device 76. The object recognition device 79 recognizes moving obstacles in the area to be observed by an infrared sensor or the like, and is configured to, when it recognizes the obstacle, transmit the recognition result to the viewpoint selection device 76 and to cause it to select the virtual viewpoint.

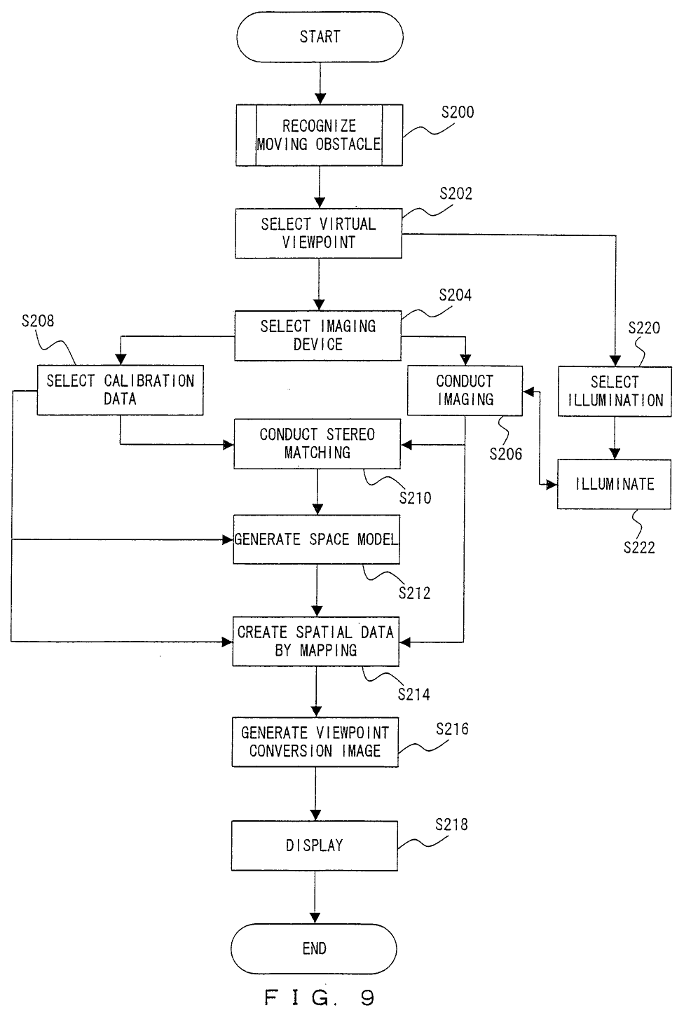

FIG. 9 is a flowchart for showing process order in a method of generating an image in the case where the image generation device for implementing the present invention is applied to a room. In FIG. 9, like processes to those of FIG. 7 are denoted by like numerals, and their explanation will be omitted.

First, in S200, the obstacle is detected and recognized by the object recognition device 79, and the virtual viewpoint whose imaging area includes the detected and recognized obstacle is selected.

Next, in S202, an arbitrary virtual viewpoint whose image is to be displayed is selected by the viewpoint selection device 76, and subsequently, the same processes are executed as in FIG. 7. Specifically, based on the recognition result by the object recognition device 79, the virtual viewpoint is selected, and the illuminator 50 and the stereo camera unit 10 are selected. The selected illuminator 50 casts light when imaging the image for the stereo distance measurement. Then, the stereo matching is conducted by using the captured image upon casting, next, the three-dimensional shape is reconstituted to be used for generating the space model for generating the viewpoint conversion image. Thereafter, mapping of the image for mapping is conducted on the generated space model, and the viewpoint conversion image is generated from the spatial data and is displayed.

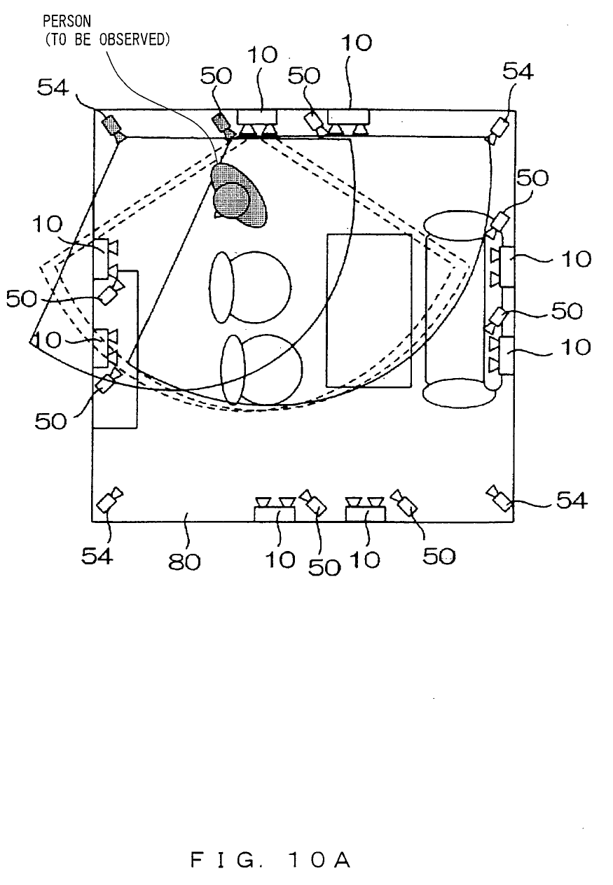

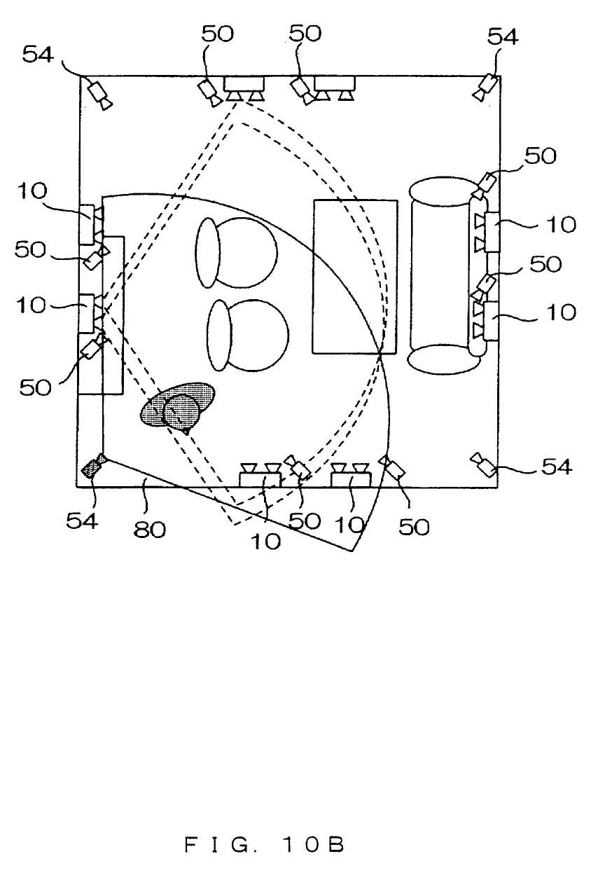

FIG. 10A and FIG. 10B show arrangement configuration examples for applying the image generation device for implementing the present invention to a room. These figures show embodiments in which the image generation device for implementing the present invention is applied to a room observation device, and the casting of light on a person is switched in the case where the virtual viewpoints are switched in accordance with the moving person.

Specifically, the stereo camera units 10 as the imaging units are provided on wall portions of an observation target room 80. The illuminator 50 is provided to each of the stereo camera units 10 for illuminating the imaged area by the supplementary light. And, the independent illuminators 54 are provided, for example, at the corner portions of the observation target room 80 independently from the illuminators 50 provided to the cameras. The virtual viewpoint is set to a position from which the entirety of the room can be viewed by the images acquired by the stereo camera units 10, and the viewpoint conversion image is then generated by the system configuration shown in FIG. 8.

Upon this, when the object recognition device 79 recognizes a person or the like moving in the room, the stereo camera unit 10 that can display the recognized moving person in the viewpoint conversion image is identified, the image data of the identified camera 10 is read in advance, the synthesized image is generated by the viewpoint conversion, and is output to be displayed on the display device 44. In parallel with this, the movement of the person is followed as shown by the transition from FIG. 10A to FIG. 10B, and the illuminator 50 provided to the identified stereo camera unit 10 and the independent illuminator 54 that can illuminate the area to be recognized by the identified camera are operated to cast supplementary light. Additionally, the independent illuminators 54 may be provided at suitable positions in a viewpoint conversion image.

By the operations as above, it is possible that the moving obstacle such as a person who has entered the room or the like can be followed and displayed while casting light or spatially modulated light from suitable positions. Naturally, the virtual viewpoints can be moved by the object recognition device in accordance with the obstacle and also in the case where the present device is provided in a vehicle instead of executing these operations in the room. Also, the embodiment of the process method in which the present device is provided in the vehicle can be used for observing the room.

In addition, in the above embodiment, the plurality of the stereo camera units can employ a configuration not only of the binocular but also of a stereo adapter type of monocular, or a configuration in which the stereo imaging is realized by a monocular camera traveling on rails. Also, the plurality of the stereo camera units can be used in a configuration where the plurality of the stereo camera units constitute a so-called trinocular stereo camera or a quadrinocular stereo camera. It is known that when the trinocular stereo camera or the quadrinocular stereo camera is used as above, a process result which is more reliable and more stable can be obtained in the three-dimensional reconstitution process and the like (See “High performance three-dimensional vision system” in the fourth issue of the 42nd volume of “Information processing” by Fumiaki Tomita, published by Information Processing Society of Japan, for example). Particularly, it is known that when the plurality of cameras are arranged in the directions of two-directional baseline length, three-dimensional reconstitution is possible for more complicated scenes. Also, when a plurality of cameras is arranged in a direction of one baseline length, a stereo camera which is based on a so-called multi-baseline method is realized, thereby, a stereo measurement with higher accuracy is realized.

By the above configuration, the image generation device for implementing the present invention can generate a high quality recognition viewpoint conversion image with the necessary supplementary light cast efficiently when the synthesis target imaging unit for the viewpoint conversion image conducts imaging of a dark region or at a night time because when the viewpoint conversion synthesized image is to be acquired, the supplementary light is cast on the area to be illuminated for the imaging units that are needed for the synthesized image.

The image generation device for implementing the present invention can display information of the surroundings of a vehicle on a display device provided nearby a driver's seat as an image viewed from a virtual viewpoint which is different from those of the cameras, and can be used as a observation device for a building and the inside/outside of a room for security purposes.

In addition, the present invention is not limited to the above described embodiments, and various modifications and alternations can be allowed without departing from the spirit of the present invention.

What is claimed is:

1. A method of generating an image, comprising:
switching directions in which supplementary light necessary for imaging is cast, in accordance with switching of viewpoints; and
converting captured images acquired by the imaging by one or a plurality of imaging units, and generating an image from a viewpoint which is different from the viewpoints of the imaging units.

2. The method according to claim 1, wherein:
the supplementary light is at least one of visible light, infrared light and spatially modulated light.

3. The method according to claim 1, wherein:
the supplementary light is cast on areas included in at least some of the captured images to be used for generating the image from the different viewpoint, and the supplementary light is not cast on areas outside the areas included in the captured images.

4. The method according to claim 1, wherein:
the imaging unit is arranged in a vehicle.

5. A device for generating an image, comprising:
a supplementary light source for illuminating an area to be imaged by one or a plurality of imaging units;
a control unit for switching directions in which supplementary light necessary for imaging by the imaging units is cast, in accordance with switching of viewpoints; and
a viewpoint conversion image generation unit for converting captured images acquired by the imaging, and generating an image from a viewpoint which is different from the viewpoints of the imaging units.

6. The device according to claim 5, wherein:
the supplementary light source is provided to the imaging unit.

7. The device according to claim 5, wherein:
the supplementary light source is provided being independent from the imaging unit and corresponding to the image from the different viewpoint.

8. The device according to claim 5, wherein:
the supplementary light source illuminates the area to be imaged by at least one of visible light, infrared light and spatially modulated light.

9. The device according to claim 5, wherein:
the imaging unit is arranged in a vehicle.

10. The device according to claim 5, wherein:
the supplementary light source is arranged in an object in which the imaging unit is arranged, together with the imaging unit.
